(19) United States
(12) Patent Application Publication
(10) Pub. No.: US 2025/0042381 A1
(43) Pub. Date: Feb. 6, 2025

(54) BRAKE SYSTEM FOR A MOTOR VEHICLE

(71) Applicant: Continental Automotive Technologies GmbH, Hannover (DE)

(72) Inventors: Christian Courth, Frankfurt (DE); Harald Biller, Eschborn (DE); Michael Hitzel, Rödermark (DE)

(73) Assignee: Continental Automotive Technologies GmbH, Hannover (DE)

(21) Appl. No.: 18/720,287

(22) PCT Filed: Dec. 5, 2022
(86) PCT No.: PCT/DE2022/200290

§ 371 Date: Jun. 14, 2024

(30) Foreign Application Priority Data
Dec. 14, 2021 (DE) 10 2021 214 332.6

(51) Int. Cl. B60T 13/68; B60T 8/34

(52) U.S. Cl. CPC B60T 13/686; B60T 8/343

(57) ABSTRACT

A brake system for a motor vehicle includes a first electrically actuatable pressure source, a first control device, a second electrically actuatable pressure source, an electrically actuatable inlet valve for each wheel brake, an electrically actuatable outlet valve for each wheel brake, a second control device, and a pressure medium reservoir. The first and second pressure sources are connected to a brake supply line to which the inlet valves are connected. An electrically actuatable circuit separation valve is arranged in the brake supply line such that when the circuit separation valve is closed, the brake supply line is separated into a first line section and a second line section. The first line section is connected to the second pressure source and at least two inlet valves, and the second line section is connected to the first pressure source and the other inlet valves.

### CROSS-REFERENCE TO RELATED APPLICATIONS

This application is a national stage application, filed under 35 U.S.C. § 371, of International Patent Application No. PCT/DE2022/200290, filed on Dec. 5, 2022, which claims priority to German patent application No. 10 2021 214 332.6, filed on Dec. 14, 2021, each of which is incorporated by reference.

### TECHNICAL FIELD

The technical field relates generally to a brake system for a motor vehicle for at least four hydraulically actuatable wheel brakes.

### BACKGROUND

A brake system having two electrically controllable pressure sources for a motor vehicle with four hydraulically activated wheel brakes is known from WO 2018/130483 A1. The brake system comprises not only wheel-specific electrically activatable inlet and outlet valves, but also an electrically activatable circuit separation valve and at least three further electrically activatable valves. These components are grouped together in a single structural unit. In addition, two electronic open-loop and closed-loop control units are provided, wherein one of the electronic open-loop and closed-loop control units activates the second pressure source and the inlet and outlet valves, while the first pressure source and all other valves are activated by the other electronic open-loop and closed-loop control unit.

DE 10 2018 222 478 A1 discloses a brake system comprising two electrically controllable pressure sources as well as a brake pedal-actuated master brake cylinder, wheel-specific electrically actuatable inlet and outlet valves, an electrically actuatable circuit separation valve, an electrically actuatable pump valve for the second electrically controllable pressure source and a normally closed sequence valve for the first electrically controllable pressure source. The second electrically controllable pressure source, the pump valve associated therewith and the inlet and outlet valves are arranged in a second module and the master brake cylinder with associated driver separation valve and simulator, the first electrically controllable pressure source, the normally closed sequence valve associated therewith and the circuit separation valve are arranged in a first module.

There remains an opportunity to provide an improved brake system which is suitable for highly automated driving and which in particular provides the highest possible availability necessary for highly automated driving.

There also remains an opportunity to keep the costs for the manufacture and assembly of the brake system as low as possible.

### SUMMARY

In one embodiment, a brake system includes a first electrically actuatable pressure source, a first electronic control device, a second electrically actuatable pressure source, an electrically actuatable inlet valve for each wheel brake and an electrically actuatable outlet valve for each wheel brake, a second electronic control device, and a pressure medium reservoir. The first pressure source and the second pressure source are connected to a brake supply line to which the at least four inlet valves are connected. An electrically actuatable circuit separation valve is arranged in the brake supply line in such a manner that, when the circuit separation valve is closed, the brake supply line is hydraulically separated into a first line section and a second line section. In this case, the first line section is hydraulically connected to the second pressure source and at least two of the at least four inlet valves. Furthermore, the second line section is hydraulically connected to the first pressure source and the other, in particular at least two, of the at least four inlet valves. In this case, the first electronic control device activates the first pressure source and the second electronic control device activates the second pressure source and the inlet and outlet valves. The circuit separation valve is also activated by the second electronic control device.

In the brake system, the first line section thus hydraulically connects the second pressure source to at least two of the at least four inlet valves (first brake circuit) and the second line section hydraulically connects the first pressure source to the other, in particular at least two, of the at least four inlet valves (second brake circuit).

The circuit separation valve is activated by the second electronic control device can be used in the event of a leak in the second brake circuit to isolate the two brake circuits by the second electronic control device and the second electronic control device can use the second pressure source to build up a pressure in at least the first brake circuit or in the wheel brakes assigned to the first brake circuit.

The disclosed system offers the advantage that the selection and arrangement of the two electrically actuatable pressure sources and the electrically actuatable valves in combination with their specific assignment to the two electronic control devices (or the specific electronic partitioning) enables separation of the properties of the hydraulic connections into unpressurized or non-pressure-resistant (suction) connections and pressure-resistant (pressure) connections.

A pressure medium reservoir which is under atmospheric pressure may be utilized.

The (or all) outlet valves may be connected to the pressure medium reservoir via a common hydraulic return line.

The circuit separation valve may be designed to be normally open, such that, in normal braking mode, when the at least four wheel brakes are pressurized by means of the first pressure source, or in an operating mode, when the at least four wheel brakes are pressurized by means of the second pressure source, it is not necessary to active of the circuit separation valve. This reduces the power consumption of the brake system and avoids potentially disturbing valve switching noises.

According to one embodiment of the brake system, when the circuit separation valve is closed, the second pressure source is hydraulically connected via the first line section to only the at least two of the at least four inlet valves, while the first pressure source is hydraulically connected via the second line section to only the other at least two of the at least four inlet valves. This means that, when the circuit separation valve is closed, the brake system is separated or divided into two hydraulic brake circuits, with each of the brake circuits comprising one of the pressure sources and a respective different pair of inlet valves. In this case, in one (first) brake circuit, the second pressure source is hydraulically connected to the at least two of the at least four inlet valves, and in the other (second) brake circuit, the first pressure source is hydraulically connected to the other inlet valves of the at least four inlet valves. In a combined operating mode, the wheel brakes which are assigned to the first brake circuit can thus be actuated by means of the second pressure source, while the wheel brakes which are assigned to the second brake circuit can be actuated by means of the first pressure source.

In one embodiment, the first pressure source is activated exclusively by the first electronic control device or the first pressure source can be activated exclusively by the first electronic control device. The second pressure source, the inlet and outlet valves and the circuit separation valve may be activated exclusively by the second electronic control device or can be activated exclusively by the second electronic control device.

The brake system may include a first electrical partition and a second electrical partition, which are electrically independent of one another, wherein the first pressure source and the first electronic control device are assigned to the first electrical partition and the second pressure source, the second electronic control device, the inlet and outlet valves and the circuit separation valve are assigned to the second electrical partition.

The first electronic control device (or the first electrical partition) may be supplied with power by a first electrical energy source and the second electronic control device (or the second electrical partition) may be supplied with power by a second electrical energy source which is independent of the first electrical energy source. The first energy source is then part of the first electrical partition, and the second energy source is part of the second electrical partition.

According to an embodiment, the brake system includes a first structural unit, in which the first electrically actuatable pressure source is arranged, and a second structural unit, in which the second electrically actuatable pressure source, the inlet and outlet valves and the circuit separation valve are arranged.

The first structural unit may include the first electronic control device and the second structural unit may include the second electronic control device.

The pressure medium reservoir may be arranged on the first structural unit.

According to a one embodiment, the first structural unit and the second structural unit are connected to one another by at most one pressure-resistant hydraulic connecting element. The first structural unit and the second structural unit may be connected to one another by several hydraulic connecting elements, but at most one—in the sense of only one—of these hydraulic connecting elements is designed to be pressure-resistant, namely the pressure-resistant hydraulic connecting element. Any other hydraulic connecting lines or elements are not designed to be pressure-resistant.

The first structural unit and the second structural unit may be connected to one other by only one hydraulic connecting element, wherein this connecting element is designed to be pressure-resistant, that is to say is the pressure-resistant hydraulic connecting element. Further, non-pressure-resistant connecting elements/lines, advantageously between the second structural unit and the pressure medium reservoir, are possible.

A pressure-resistant connecting element or a pressure-resistant connection is preferably understood to mean that the connecting element or the connection is configured for a maximum operating pressure of one of the pressure sources, in particular the first pressure source, and/or the wheel brakes. The pressure-resistant connecting element or the pressure-resistant connection is particularly preferably configured for a pressure of about 180-220 bar. The pressure-resistant connecting element or the pressure-resistant connection is very particularly preferably configured for a pressure of about 200 bar.

A non-pressure-resistant connecting element or a non-pressure-resistant connection is preferably understood to mean that the connecting element or the connection is not designed for the maximum operating pressure of the wheel brakes. A non-pressure-resistant connecting element or a non-pressure-resistant connection is particularly preferably configured for a maximum pressure of about 10 bar.

A division into two structural units offers the advantage that both structural units are smaller and lighter and therefore easier to handle compared to implementation in only one structural unit. They can also be manufactured more easily in existing production plants. On the other hand, when divided into two structural units, each hydraulic connection between these structural units leads to considerable effort and costs. It is therefore particularly advantageous to keep the number of hydraulic connections as low as possible. It has been shown that it is advantageous to isolate the various functions of hydraulic connections as clearly as possible. This means that connections via which pressure medium is drawn in can be designed with the largest possible diameter so that they have the smallest possible hydraulic resistance. For this, it is advantageous if such connections do not have to be pressure-resistant. Conversely, pressure-bearing connections should not have a suction function.

According to one embodiment, the first pressure source is connected to the brake supply line, in particular the first line section of the brake supply line, via an electrically actuatable first separation valve, wherein the first separation valve is activated by the second electronic control device. The first separation valve can therefore be closed and a flow of pressure medium from the brake supply line in the direction of the first pressure source or first structural unit can therefore be prevented by means of the second electronic control device, for example in the event of a failure of the first electronic control device.

The first separation valve may be designed to be normally open. Closing the first separation valve, for example in the event of a leak in the first pressure source or the first structural unit, can prevent a flow of pressure medium from the brake supply line into the first pressure source or into the first structural unit. The first pressure source or the first structural unit can also be hydraulically isolated from the brake supply line by means of the first separation valve, for example if the brake system is to be or must be operated in an operating mode (for example in the event of an electrical failure of the first electronic control device) in which the at least four wheel brakes are pressurized by means of the second pressure source.

The first separation valve may be activated exclusively by the second electronic control device or can be activated exclusively by the second electronic control device.

The first separation valve may be assigned to the second electrical partition.

The first separation valve may be arranged in the second structural unit.

The first separation valve may include a check valve connected in parallel therewith, the check valve opening in the direction of the brake supply line. The check valve is advantageously arranged in the second structural unit.

The first separation valve may include an electrically actuatable, in particular normally closed, third separation valve connected in parallel therewith, the third separation valve being activated by the second electronic control device. The third separation valve is advantageously arranged in the second structural unit.

As an alternative the first separation valve is activated by the first electronic control device, and is arranged in particular in the first structural unit, and is designed to be normally closed. In the event of a leak in the first pressure source, closing the first separation valve can thus prevent pressure medium from flowing out of the first pressure source.

As an alternative, the first pressure source is connected to the brake supply line without an electrically actuatable valve being intermediately connected.

The first pressure source may be connected to the pressure medium reservoir via an electrically actuatable second separation valve, wherein the second separation valve is activated by the first electronic control device. The second separation valve may be designed to be normally open. It is possible for pressure medium to flow from the wheel brakes into the pressure medium reservoir via the second separation valve, for example in the electrically deenergized state of the brake system, which is advantageous to ensure the depressurization of the wheel brakes (reduction of residual braking torque), for example when the vehicle is parked. The second separation valve may include a check valve connected in parallel therewith, the check valve opening in the direction of the first pressure source.

The second separation valve may be activated exclusively by the first electronic control device or can be activated exclusively by the first electronic control device.

The second separation valve may be assigned to the first electrical partition.

The second separation valve may be arranged in the first structural unit.

The first pressure source or the pressure chamber thereof may be connected to the pressure medium reservoir via a check valve which opens in the direction of the first pressure source, in particular to draw pressure medium. The check valve may be provided in addition to the second separation valve.

The first structural unit may include at least one first hydraulic port for connection to the pressure medium reservoir and a second hydraulic port for connection to the second structural unit, wherein the second hydraulic port is connected to the pressure-resistant hydraulic connecting element. The second hydraulic port must accordingly be designed for a pressure-resistant connection. The first hydraulic port must only be designed for an unpressurized (atmospheric) or non-pressure-resistant connection.

The first pressure source, in particular for drawing pressure medium, may be connected to the first hydraulic port, in particular via a check valve which opens in the direction of the first pressure source, and the first pressure source, in particular for actuating the at least four wheel brakes, may be connected to the second hydraulic port.

According to a one embodiment, the second structural unit includes at least four hydraulic wheel ports for connection to the wheel brakes, a first hydraulic port for connection to the pressure medium reservoir, and a second hydraulic port for connection to the first structural unit, wherein the second hydraulic port is connected to the pressure-resistant hydraulic connecting element. The second hydraulic port of the second structural unit is accordingly advantageously designed for a pressure-resistant connection. For actuation of the wheel brakes, the wheel ports of the second structural unit are also designed for a pressure-resistant connection. In contrast, the first hydraulic port of the second structural unit must only be designed for an unpressurized (atmospheric) or non-pressure-resistant connection.

The second structural unit may not include any further hydraulic port in addition to the wheel ports and the first (atmospheric) and the second (pressure-resistant) port.

According to a one embodiment, the first hydraulic port of the first structural unit and the first hydraulic port of the second structural unit are connected to different chambers of the pressure medium reservoir. An (at least partial) separation of the pressure medium reservoirs for the first structural unit or first pressure source as well as the second structural unit or second pressure source is thus ensured. This increases the availability of the brake system in the event of a leak.

The first pressure source may be formed by a cylinder-piston arrangement with a hydraulic pressure chamber, the piston of which is advanced for a build-up of brake pressure, and is retracted for a dissipation of brake pressure, by an electromechanical actuator.

The first pressure source may be formed by a cylinder-piston arrangement with a hydraulic pressure chamber and a pressure port, the piston of which is advanced and retracted by an electromechanical actuator. The pressure port may be hydraulically connected to the pressure medium reservoir via a check valve which opens in the direction of the pressure chamber. The pressure port may be hydraulically connected to the pressure medium reservoir via a second separation valve. The pressure port may be hydraulically connected to the brake supply line, in particular to the second line section of the brake supply line, via a first separation valve.

The first pressure source may be formed by a cylinder-piston arrangement with a hydraulic pressure chamber, a suction port, and a pressure port, the piston of which is advanced and retracted by an electromechanical actuator. The suction port may be hydraulically connected to the pressure medium reservoir via a check valve which opens in the direction of the pressure chamber. The pressure port may be hydraulically connected to the pressure medium reservoir via a second separation valve. The pressure port is very particularly preferably hydraulically connected to the brake supply line, in particular to the second line section of the brake supply line, via a first separation valve.

The first pressure source may be formed by a cylinder-piston arrangement with a hydraulic pressure chamber, a suction port, a pressure port, and a breather hole, the piston of which is advanced and retracted by an electromechanical actuator. The suction port may be hydraulically connected to the pressure medium reservoir via a check valve which opens in the direction of the pressure chamber. The breather hole may be hydraulically connected to the pressure medium reservoir. In the case of a cylinder-piston arrangement with a breather hole, no connection between the pressure port and the pressure medium reservoir by way of a second separation valve is required or provided. The pressure port may be hydraulically connected to the brake supply line, in particular to the second line section of the brake supply line, via a first separation valve.

The first pressure source may be formed and arranged hydraulically in such a way that it can be activated in such a way that a hydraulic connection between the pressure medium reservoir and the brake supply line is established.

According to one embodiment, the second pressure source is of dual-circuit or multi-circuit design. The second pressure source may be designed as a two-piston pump or multi-piston pump.

The pressure sides of the dual-circuit or multi-circuit pressure source may be interconnected (to form a common pressure port) and the suction sides of the dual-circuit or multi-circuit pressure source are interconnected (to form a common suction port). The suction port (and thus the suction sides) may be connected to the pressure medium reservoir, in particular to the return line of the outlet valves. The pressure port (and thus the pressure sides) may be connected to the brake supply line, particularly to the first line section of the brake supply line.

In one embodiment, the brake system does not include any other pressure source in addition to the first and second pressure sources. The brake system may include neither a further electrically actuatable pressure source nor a driver-actuatable pressure source, such as a master brake cylinder, which is operatively connected, for example hydraulically or mechanically connected, to at least one of the wheel brakes for actuation thereof.

According to one embodiment, the brake system comprises an actuating unit for a vehicle driver, wherein the actuating unit is connected to at least one of the two electronic control devices for transmitting a driver demand signal and wherein there is no mechanical-hydraulic connection from the actuating unit to the wheel brakes.

The actuating unit may include a first sensor for detecting a braking demand of the vehicle driver and a second sensor for detecting a braking demand of the vehicle driver which is independent of the first sensor. The first sensor may be assigned to one of the two electrical partitions and the second sensor may be assigned to the other of the two electrical partitions.

The first sensor may be connected to one of the two electronic control devices on the signal side and the second sensor is preferably connected to the other of the two electronic control devices on the signal side.

The disclosed brake system offers the advantage that, even in the event of a failure of one of the two redundant electrical pressure sources, for example owing to a failure of the electrical energy source assigned thereto or of the electronic control device assigned thereto or a mechanical fault or a leak in the pressure source itself, the brake system can maintain the most important residual braking functions.

The disclosed brake system is therefore particularly suitable for the realization of highly automated driving functions.

### BRIEF DESCRIPTION OF THE DRAWINGS

Further embodiments of the disclosure are derived from the dependent claims and the following description with reference to figures, in which, schematically:

FIG. 1 shows a first exemplary embodiment of a brake system,

FIG. 2 shows a second exemplary embodiment of a brake system,

FIG. 3 shows a third exemplary embodiment of a brake system,

FIG. 4 shows a fourth exemplary embodiment of a brake system,

FIG. 5 shows a fifth exemplary embodiment of a brake system,

FIG. 6 shows a further exemplary embodiment of a brake system,

FIG. 7 shows a further exemplary embodiment of a brake, and

FIG. 8 shows a further exemplary embodiment of a brake system.

### DETAILED DESCRIPTION

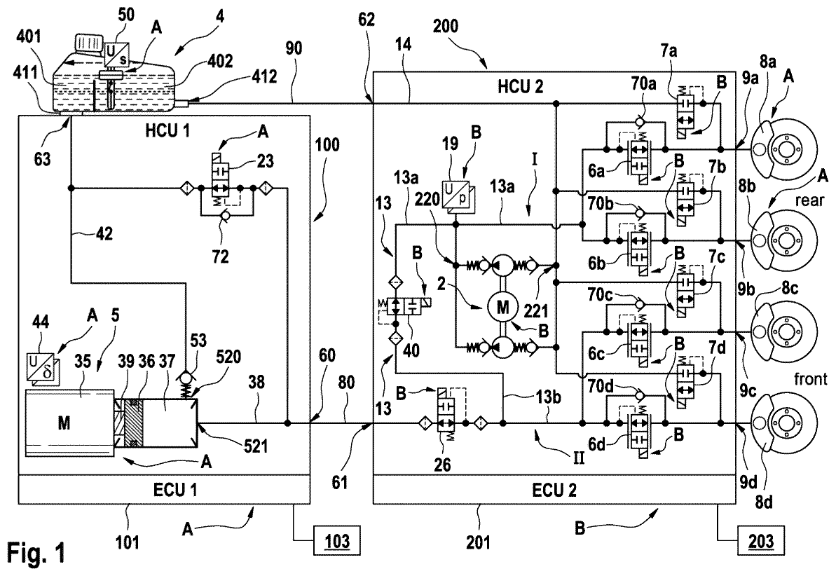

FIG. 1 highly schematically illustrates a first exemplary embodiment of a brake system for a motor vehicle. As an example, the brake system is designed for actuating four hydraulically actuatable wheel brakes 8a-8d; an extension to more wheel brakes is easily possible. As an example, the wheel brakes 8a, 8b are assigned to the rear axle (rear) and the wheel brakes 8c, 8d are assigned to the front axle (front) of the vehicle.

The brake system includes a first electrically actuatable pressure source 5, a first electronic control device 101 (ECU1) which activates the first pressure source 5, a second electrically actuatable pressure source 2, an electrically actuatable inlet valve 6a-6d per wheel brake 8a-8d, and an electrically actuatable outlet valve 7a-7d per wheel brake 8a-8d, a second electronic control device 201 (ECU2) which activates the second pressure source 2 and the inlet and outlet valves 6a-6d, 7a-7d. The brake system furthermore includes a pressure medium reservoir 4. The first pressure source 5 and the second pressure source 2 are connected to a brake supply line 13 to which the four inlet valves 6a-6d are connected. An electrically actuatable circuit separation valve 40 is arranged in the brake supply line 13 such that, when the circuit separation valve 40 is closed, the brake supply line 13 is hydraulically separated into a first line section 13a and a second line section 13b. In this case, the first line section 13a is hydraulically connected to the second pressure source 2 and two of the four inlet valves 6a, 6b and the second line section 13b is hydraulically connected to the first pressure source 5 and the other two of the four inlet valves 6c, 6d. The circuit separation valve 40 is activated by the second electronic control device 201. The circuit separation valve 40 is advantageously designed to be normally open.

The first pressure source 5 and the second pressure source 2 are thus connected on the pressure side to the brake supply line 13 to which the four inlet valves 6a-6d are connected. All four wheel brakes 8a-8d can thus be actuated by means of the first pressure source 5 or by means of the second pressure source 2.

When the circuit separation valve 40 is closed, the brake supply line 13 is separated into the first line section 13a to which the inlet valves 6a, 6b and the wheel brakes 8a, 8b are connected and the second line section 13b to which the inlet valves 6c, 6d and the wheel brakes 8c, 8d are connected. When the circuit separation valve 40 is closed, the brake system is thus separated or divided into two hydraulic brake circuits I and II. Here, in the first brake circuit I, the pressure source 2 is connected to only the wheel brakes 8a and 8b (via the first line section 13a) and, in the second brake circuit II, the first pressure source 5 is connected to only the wheel brakes 8c and 8d (via the second line section 13b). The circuit separation valve 40 is advantageously designed to be normally open.

The brake system comprises, for example, a first structural unit 100 designed, for example, as a first electrohydraulic brake control unit (HECU1) with a valve block HCU1 and the first electronic control device 101 (ECU1), a second structural unit 200 designed, for example, as a second electrohydraulic brake control unit (HECU2) with a valve block HCU2 and the second electronic control device 201 (ECU2), and the pressure medium reservoir 4.

The pressure medium reservoir 4, which is under atmospheric pressure, is advantageously arranged on the first structural unit 100. The pressure medium reservoir 4 comprises, for example, two chambers, wherein the first chamber 401 is assigned a first reservoir port 411 and the second chamber 402 is assigned a second reservoir port 412.

The first electrically actuatable pressure source 5 is arranged in the first structural unit 100.

The second electrically actuatable pressure source 2 and the wheel-specific brake pressure modulation valves, that is to say inlet and outlet valves 6a-6d, 7a-7d, are arranged in the second structural unit 200.

As already mentioned, the brake system includes, for each hydraulically actuatable wheel brake 8a-8d, an inlet valve 6a-6d and an outlet valve 7a-7d which are hydraulically interconnected in pairs via central ports and are each connected to a hydraulic wheel port 9a-9d to which the corresponding wheel brake 8a-8d is connected. A check valve 70a-70d which opens in the direction of the brake supply line 13 is connected in parallel with each of the inlet valves 6a-6d. The outlet ports of the outlet valves 7a-7d are connected via a common return line 14 to a hydraulic port 62 of the second structural unit 200, which is connected to the pressure medium reservoir 4, for example to the second reservoir port 412 thereof or to the chamber 402 thereof. The input ports of all inlet valves 6a-6d can be supplied by means of the brake supply line 13 (that is to say when the circuit separation valve 40 is open) with a pressure which is provided by the first pressure source 5 or, for example in the event of a failure of the first pressure source 5, by the second pressure source 2.

The second electrically controllable pressure source 2 includes a pressure port 220, which is hydraulically connected to the first line section 13a, and a suction port 221, which is hydraulically connected to the pressure medium reservoir 4, for example via the return line 14 and the port 62. The port 62, and thus the suction port (the suction side(s)) 221 of the pressure source 2, is, for example, directly connected via a line or a hose 90 to the pressure medium reservoir 4. This connection 90 does not bear pressure and may therefore have a large diameter. As an example, the port 62 is hydraulically connected by means of the connecting line/connecting hose 90 to the second reservoir port 412 (and thus the second chamber 402) of the pressure medium reservoir 4.

The first electrically controllable pressure source 5 is in the form of a hydraulic cylinder-piston arrangement (or a single-circuit electrohydraulic actuator (linear actuator)), the piston 36 of which can be actuated, in particular advanced and retracted, in order to build up and dissipate a pressure in a pressure chamber 37, by a schematically indicated electric motor 35 via a likewise schematically illustrated rotation-translation mechanism 39. The piston 36 delimits the pressure chamber 37 of the pressure source 5. For the activation of the electric motor, a rotor position sensor 44 is provided, which detects the rotor position of the electric motor 35 and which is merely schematically indicated.

The first pressure source 5, or the pressure chamber 37 thereof, is releasably connected to the second line section 13b or the brake supply line 13 via an electrically actuatable, advantageously normally open, separation valve 26. The separation valve 26 is activated by the second electronic control device 201.

As an example, the pressure chamber 37 of the first electrically controllable pressure source 5 is connected to a system pressure line section 38, by means of which the pressure source 5 is hydraulically connected to a hydraulic port 60 of the first structural unit 100, which is hydraulically connected via a hydraulic connecting element 80 to a hydraulic (pressure) port 61 of the second structural unit 200. The separation valve 26 is hydraulically arranged between the port 61 and the second line section 13b of the brake supply line 13. The separation valve 26 is advantageously arranged in the second structural unit 200.

The connection 80 is the only hydraulic pressure connection, in particular the only hydraulic connection, between the first structural unit 100 and the second structural unit 200. It is a hydraulic connection for transmitting a brake pressure to actuate the wheel brakes 8a-8d (hence pressure connection). The connecting element 80 must therefore be designed to be pressure-resistant, for example as a pressure-resistant brake hose.

The first pressure source 5 is connected to the pressure medium reservoir 4 via a check valve 53 which opens in the direction of the first pressure source 5.

As an example, the pressure chamber 37 is hydraulically connected to a hydraulic port 63 of the first structural unit 100 via a (replenishment) line 42 (formed in the first structural unit 100), irrespective of the actuation state of the piston 36. The port 63 is hydraulically connected to the pressure medium reservoir 4, for example to the first reservoir port 411 thereof and thus the first chamber 401 thereof. The check valve 53 which closes in the direction of the pressure medium reservoir 4 is arranged in the (replenishment) line 42. The exemplary pressure source/cylinder-piston arrangement 5 has no breather holes according to the example.

Furthermore, the first pressure source 5 is connected to the pressure medium reservoir 4 via an electrically actuatable, advantageously normally open, second separation valve 23. The second separation valve 23 is activated by the first electronic control device 101.

As an example, the pressure chamber 37 is hydraulically connected via the line section 38 and the electrically actuatable second separation valve 23 to the hydraulic port 63 (and the (replenishment) line 42). According to the example, a check valve 72 which opens in the direction of the pressure chamber 37 is connected in parallel with the second separation valve 23.

In addition to the (pressure medium reservoir) port 63 and the (pressure) port 60, the first structural unit 100 does not include another hydraulic port according to the example.

The second electrically controllable pressure source 2 is designed, for example, as a two-piston pump, the two pressure sides of which are interconnected (to form the pressure port 220) and the two suction sides of which are interconnected (to form the suction port 221). The suction port 221 (and thus the two suction sides) of the pressure source 2 is hydraulically connected to the return line 14 and thus to the pressure medium reservoir 4 and the port 62, respectively. The pressure port 220 (and thus the two pressure sides) of the pressure source 2 are connected to the first line section 13a of the brake supply line 13.

The brake system includes, for example, in the brake circuit I (line section 13a), a pressure sensor 19, which is thus assigned to the second pressure source 2. This is advantageous for protection against bursting when the circuit is disconnected, that is to say when the circuit separation valve 40 is closed. However, the pressure sensor 19 may also be arranged in the brake circuit II or a second pressure sensor may be provided, such that each of the two brake circuits I and II can be directly monitored by means of a pressure sensor.

In the example, the brake system comprises, for leakage monitoring purposes, a level-measuring device 50 for determining a pressure medium level in the pressure medium reservoir 4.

As an example, the components 5, 53, 23, 72 and the line sections 38, 42 are arranged in the first valve block HCU1 and the components 2, 6a-6d, 7a-7d, 26, 19 and the line sections 13a, 13b (and the line sections between the inlet and outlet valves on the one hand and the wheel ports on the other hand) are arranged in the second valve block HCU2.

As already mentioned, each valve block HCU1, HCU2 is assigned one of the electronic control devices 101, 201 (ECU1, ECU2). Each electronic control device 101, 201 comprises electrical and/or electronic elements (for example microcontrollers, power modules, valve drivers, other electronic components, etc.) for activating the electrically actuatable components of the associated valve block (structural unit) and, if necessary, for evaluating the signals of the sensors assigned to this valve block (structural unit). The valve block and electronic control device are advantageously designed in a known manner as an electrohydraulic unit (HECU).

For the electrical attachment, connection and supply of the individual electrical or electrically actuatable, activatable, evaluatable or similar components of the brake system, a first electrical partition A and a second electrical partition B are provided, which are electrically independent of one another.

In the figures, those electrical components which are assigned or belong to the first electrical partition A are indicated by an arrow A, while those electrical components which are assigned or belong to the second electrical partition B are indicated by an arrow B.

The electronic control device 101 is assigned to or belongs to the first electrical partition A, while the second electronic control device 201 is assigned to or belongs to the second electrical partition B. Accordingly, the electronic control device 101 and the second electronic control device 201 are electrically independent.

To supply the brake system with electrical energy, a first electrical energy source 103, for example a vehicle electrical system, and a second electrical energy source 203, for example a vehicle electrical system, which is independent of the first energy source are provided. The first electrical energy source 103 supplies the first electrical partition A with energy and the second electrical energy source 203 supplies the second electrical partition B.

The first electronic control device 101 activates the first pressure source 5. Accordingly, the first pressure source 5 is assigned to or associated with the first electrical partition A. As an example, the first pressure source 5 is supplied with energy (from the first electrical energy source 103) via the first electronic control device 101.

The second electronic control device 201 activates the second pressure source 2. Accordingly, the second pressure source 2 is assigned to or associated with the second electrical partition B. As an example, the second pressure source 2 is supplied with energy (from the second electrical energy source 203) via the second electronic control device 201.

As an example, the first pressure source 5 can be or is activated exclusively by the first electronic control device 101, and the second pressure source 2 can be or is activated exclusively by the second electronic control device 201. It would basically be conceivable for the electric motor of a pressure source to be equipped for example with two electrically independent motor coils; it would thus be possible for the pressure source to be activated by the two independent electrical devices. This would however be associated with further redundancies, for example double connecting lines, etc., and would thus be more expensive.

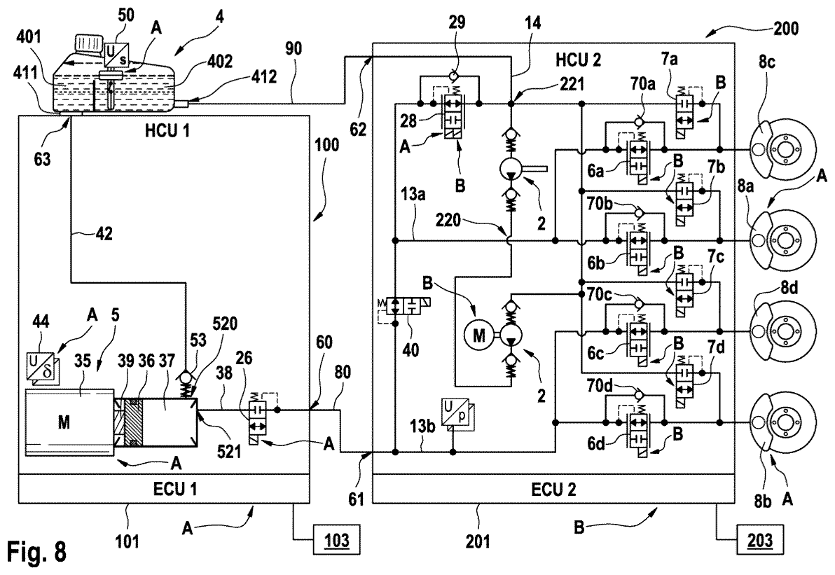

The remaining components of the brake system are advantageously assigned to either the first electronic control device 101 (partition A) or the second electronic control device 201 (partition B). That is to say said components are activated or actuated by said control device and/or supplied with electrical energy by said control device, and/or are connected on the signal side to said control device and/or are evaluated by said control device. In order to avoid further redundancies, it is advantageously the case that a component is activatable or actuatable by, or suppliable with electrical energy by, or connected in signal-transmitting fashion to, or evaluatable by, only or exclusively one of the two electronic control devices 101, 201, but not the other electronic control device (exception: see exemplary embodiment of FIG. 8 with a dual-activatable valve 28).

The inlet and outlet valves 6a-6d, 7a-7d are assigned to the second electrical partition B and are activated by the second electronic control device 201. The circuit separation valve 40 is likewise assigned to the second electrical partition B and is activated by the second electronic control device 201.

The separation valve 26 for the separation of the first pressure source 5 and the brake supply line 13 is also assigned, for example, to the second electrical partition B and is activated by the second electronic control device 201.

The pressure sensor 19 is also assigned to the second electrical partition B. The signals from said sensor are fed to the second electronic control device 201 and evaluated and processed thereby.

The separation valve 23 is assigned to the first electrical partition A and is activated by the first electronic control device 101.

Furthermore, the signals from the level measuring device 50 are supplied to the first electronic control device 101 and evaluated and processed thereby.

The brake system may include electrically actuatable parking brakes on the rear wheels (rear). Said parking brakes are advantageously activated and actuated by the first electronic control device 101, characterized by A at the wheel brakes 8a, 8b in FIG. 1.

The exemplary brake system includes a primary pressure source 5 and a secondary pressure source 2, each of which is electrically actuated by an ECU (electronic control unit) and has a suction port and a pressure port. No brake fluid can flow into the pressure port 220 of the secondary pressure source 2 even in the electrically deenergized state. The primary pressure source 5 may be a linear actuator with a replenishment check valve 53 and the secondary pressure source 2 is a piston pump. The secondary pressure source 2 may generate a higher pressure than the primary pressure source 5.

The suction ports 221 and 520 of the two pressure sources 2 and 5, respectively, are connected to a pressure medium reservoir 4, preferably each with one of two separate chambers (402, 401).

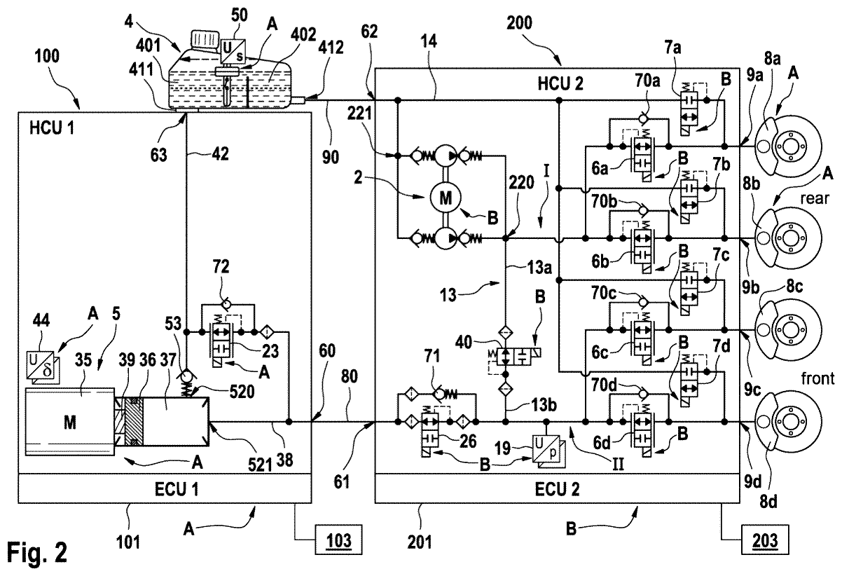

The pressure port 521 of the primary pressure source 5 is connected to a primary circuit node (second line section 13b) via the electromagnetic valve 26, also referred to as a pressure activation valve. A check valve 71 can be connected in parallel with the valve 26 (see for example FIG. 2), which allows a volume flow from the primary pressure source 5 to the primary circuit node (13b).

The pressure port 220 of the secondary pressure source 2 is connected directly (without intermediate connection of a valve) to a secondary circuit node (first line section 13a).

The two circuit nodes (line sections 13a, 13b) are connected to one another via an electromagnetic valve 40, also referred to as a circuit separation valve.

The two circuit nodes are connected to wheel brakes 8a-8d via electromagnetic inlet valves 6a-6d, for example the primary circuit node (13b) is connected to the wheel brakes 8c, 8d of the front axle and the secondary circuit node (13a) is connected to the wheel brakes 8a, 8b of the rear axle.

The wheel brakes 8a-8d are connected to the pressure medium reservoir 4 via electromagnetic outlet valves 7a-7d.

The output port 521 of the primary pressure source 5 is connected to the pressure medium reservoir 4 via an electromagnetic valve 23, also referred to as a pressure dissipation valve.

The valve 26, the valve 40, and the valve 23 are preferably designed to be normally open.

In normal braking mode, the pressure in the wheel brakes 8a-8d is built up by the primary pressure source 5 with the separation valve 23 closed. The pressure is dissipated to the primary pressure source 5 (return of the piston 36) or to the pressure medium reservoir 4 via the separation valve 23.

The wheel brake pressure is modulated by the inlet and outlet valves 6a-6d, 7a-7d on a wheel-by-wheel basis as required (for example in the case of an anti-lock braking control or other brake control function). If necessary, the separation valve 26 is closed so that the primary pressure source 5 can replenish additional volume from the pressure medium reservoir 4.

If a particularly high volume flow rate is required or requested, both pressure sources 5 and 2 may operate simultaneously. In this case, the pressure is dissipated at least partially via the separation valve 23, which is preferably designed as an analog valve, that is to say it can control its flow. If a particularly high pressure is requested, the separation valve 26 may be closed and the secondary pressure source 2 increases the pressure beyond the pressure of the primary pressure source 5.

Outside of braking operations, atmospheric pressure equalization is permanently ensured via the separation valve 23 and the separation valve 26.

In the event of a leak in the brake system, the circuit separation valve 40 is preferably closed and the system is thus divided into two independent brake circuits I and II.

The separation valve 23 is preferably activated by the primary ECU 101. The separation valve 26 is preferably activated by the secondary ECU 201. The following description of operation in the event of a fault refers to this valve assignment.

If the primary system (structural unit 100) fails electrically, in particular the primary ECU 101 or the power supply 103 thereof (partition A failure), the secondary ECU 201 closes the separation valve 26 to build up pressure via the secondary pressure source 2. Pressure is dissipated via the separation valve 26 or via the outlet valves 7a-7d. The inlet and outlet valves are preferably activated by the secondary ECU 201 (partition B), so that the pressure can be modulated on a wheel-by-wheel basis.

If the secondary system (structural unit 200) fails electrically, in particular the secondary ECU 201 or the power supply 203 thereof (partition B failure), the pressure is built up and dissipated as in normal operation via the primary pressure source 5 and, if necessary, the separation valve 23. There is no need for wheel-specific pressure control, but a joint modulation of the wheel pressures remains possible in order to prevent the vehicle from being destabilized by wheel-locking.

The assignment of the valves to the two ECUs may be as described above, the circuit separation valve 40 is activated by the secondary ECU 201, and the system is divided into two structural units 100 and 200 with two hydraulic connecting lines, namely the pressure-resistant connecting element 80 and the unpressurized or non-pressure-resistant connecting line 90. These two structural units 100, 200 may each comprise one of the two ECUs, the assigned pressure source and the assigned valves.

FIG. 2 schematically illustrates a second exemplary embodiment of a brake system according. In contrast to the first exemplary embodiment of FIG. 1, a check valve 71 is connected in parallel with the separation valve 26 of the second structural unit 200, said check valve enabling a volume flow from the primary pressure source 5 to the line section 13b, in order to reduce the hydraulic resistance of the valve 26 in the pressure build-up direction. Furthermore, the pressure sensor 19 is arranged on the line section 13b (brake circuit II).

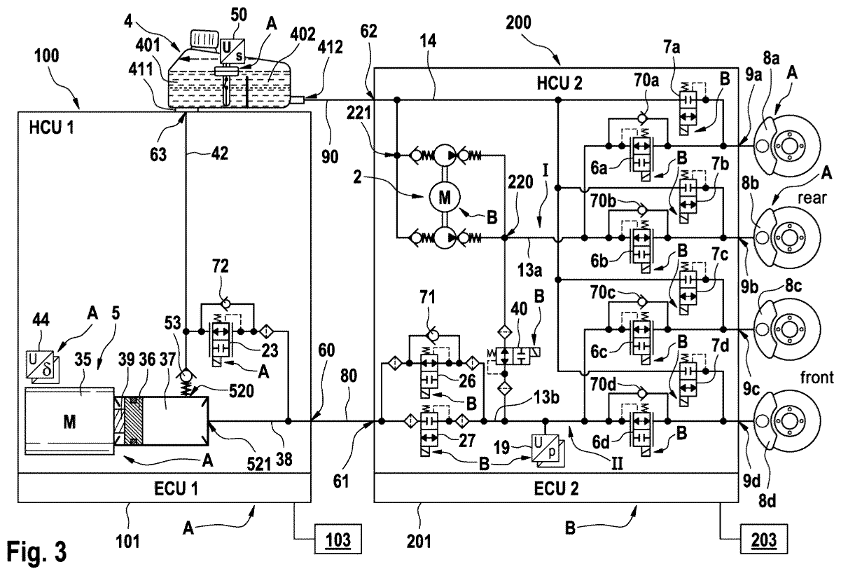

FIG. 3 schematically illustrates a third exemplary embodiment of a brake system. In contrast to the second exemplary embodiment of FIG. 2 (in the second structural unit 200), another electrically actuatable valve 27 is provided, which is designed to be normally closed. The valve is connected in parallel with the separation valve 26. The valve 27 is activated by the second electronic control device 201.

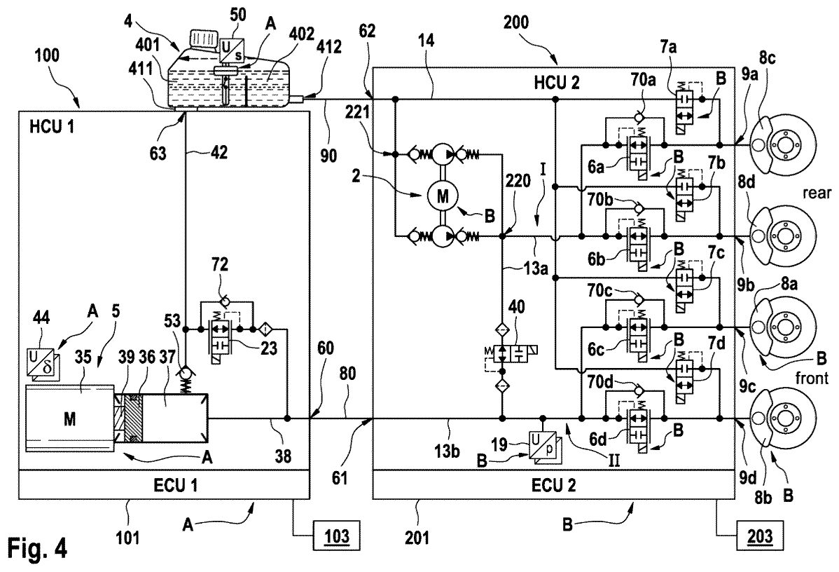

FIG. 4 schematically illustrates a fourth exemplary embodiment of a brake system. In contrast to the brake system of FIG. 1, the separation valve 26 is omitted. The pressure source 5 is directly connected to the first line section 13a.

However, the saving of the separation valve 26 leads to several disadvantages. If the first structural unit 100 fails (for example due to an electrical fault in the ECU1 or partition A, or due to a leak in the structural unit 100), the pressure source 2 can only build up pressure in the first line section 13a (with the circuit separation valve 40 closed). The pressure source 5 can only be replenished if inlet valves 6c, 6d without check valves 70c, 70d (not shown) are used in the second line section 13b.

Advantageously, therefore, the vehicle axles are reversed in this exemplary embodiment, that is to say the second line section 13b is connected to the wheel brakes 8a, 8b of the rear axle (rear) and the first line section 13a, which is connected to the pressure source 2, is connected to the wheel brakes 8c, 8d of the front axle.

The electrically actuatable parking brakes on the rear wheels (rear) are advantageously activated and actuated by the second electronic control device 201 (characterized by B at the wheel brakes 8a, 8b in FIG. 4).

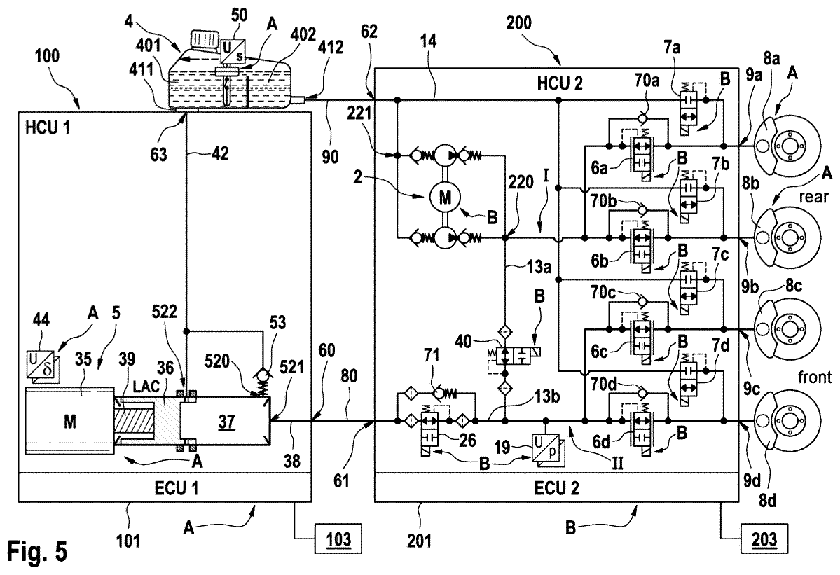

FIG. 5 schematically illustrates a fifth exemplary embodiment of a brake system. In contrast to the brake system of FIG. 2, the separation valve 23 including the check valve 23 is omitted. The hydraulic connection to the valves 23, 72 between line sections 38 and 42 is thus omitted. For this purpose, the pressure source 5 also includes a mechanism for atmospheric connection. As an example, the cylinder-piston arrangement 5 (linear actuator) is designed with a breather hole 522.

A corresponding design (omission of valves 23, 72 and design of the pressure source 5 with breather hole 522) is also possible in the brake systems of the embodiments of FIGS. 1, 3 and 4.

The saving of the separation valve 23 thus leads to an additional outlay in the pressure source 5. The above-described function of the separation valve 23 to reduce additional volume provided by the pressure source 2 must be taken over by the outlet valves 7a-7d, which is less convenient.

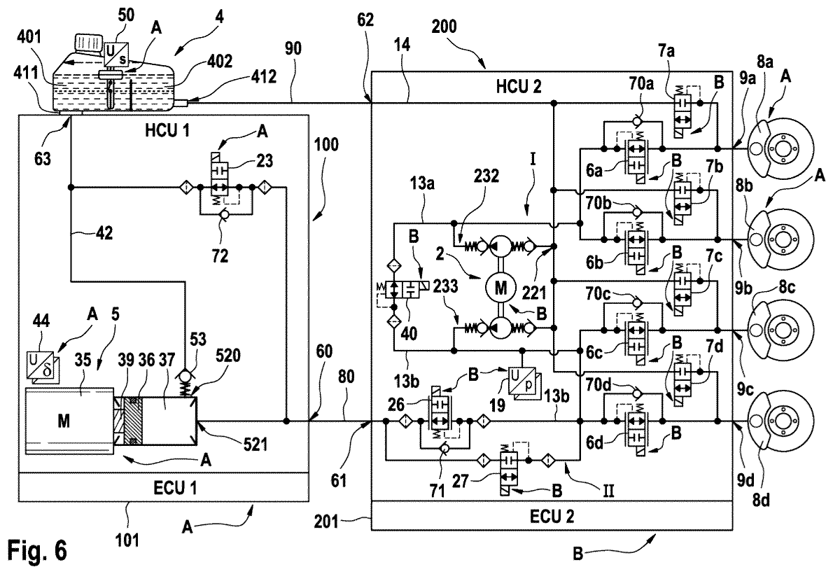

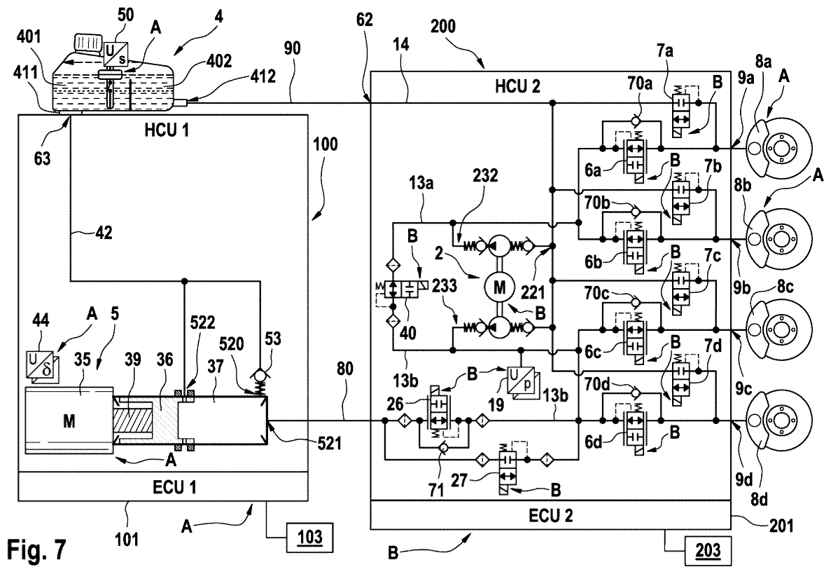

According to further exemplary embodiments of the brake system (see for example FIGS. 6 and 7), the second pressure source 2 is designed in a dual-circuit manner, in particular as a two-piston pump. The two suction sides in this case remain connected (suction port 221) and are connected to the return line 14. The two pressure sides are not interconnected. One of the pressure sides (pressure port 232) is connected to the first line section 13a, the other pressure side (pressure port 233) is connected to the second line section 13b. This design of the pressure source 2 is possible in all exemplary embodiments described so far. This design has the advantage that, even after failure of the first partition A (for example the first electronic control device 101), a dual-circuit operation is possible, that is to say that both line sections 13a and 13b can be pressurized by means of the pressure source 2. A disadvantage is the reduced pressure build-up dynamics in the line section 13a in dual-circuit operation. For example, FIGS. 6 and 7 show corresponding exemplary embodiments starting from the brake systems of FIGS. 3 and 5.

FIG. 8 illustrates a further exemplary embodiment of a brake system. The differences from the first exemplary embodiment of FIG. 1 are described below.

The first structural unit 100 (or valve block HCU1) comprises, in addition to the first pressure source 5 and the (replenishment) line 42 thereof with the check valve 53, a normally closed separation valve 26, which is activated by the first electronic control device 101. The hydraulic connection to the valves 23, 72 between the line sections 38 and 42 is omitted; the pressure source 5 does not include breather holes. The separation valve 26 is arranged hydraulically between the pressure source 5 and the line section 13b of the brake supply line 13, namely between the pressure source 5 and the port 60 of the first structural unit 100.

The second structural unit 200 (or valve block HCU2) comprises, in addition to the second pressure source 2 and the inlet and outlet valves 6a-6d, 7a-7d and the circuit separation valve 40, which are activated by the second electronic control device 201, a normally open separation valve 28, which is connected in parallel with the pressure source 2, that is to say the suction sides of the pressure source 2 are connected to the pressure sides of the pressure source 2 and the return line 14 is connected to the line section 13a. A check valve 29 which closes in the direction of the pressure medium reservoir 4 (the return line 14) is connected in parallel with the separation valve 28. The separation valve 28 is preferably designed as an analog valve. The separation valve 28 is designed to be dual-activated, that is to say it comprises two separate, electrically independent actuating coils, wherein one coil is activated by the first electronic control device 101 (partition A) and the other coil is activated by the second electronic control device 201 (partition B).

The selection and arrangement of the electrically actuatable valves, the electronic partitioning and in particular the assignment between electrically actuatable valves and electronic control devices enable a high availability of the brake system with at the same time advantageous arrangement of the components of the brake system in two electrohydraulic brake control units HECU1 and HECU2. It is possible for the two brake control units HECU1 and HECU2 to only need a pressure-resistant connection, which hydraulically connects them to one another, in addition to the unpressurized or non-pressure-resistant connections to the pressure medium reservoir. The at least four connections between the second structural unit 200 (or the wheel connections (9a-9d)) and the wheel brakes 8a-8d are also pressure-resistant connections.

The division into two brake control units HECU1, HECU2 offers the advantage that both brake control units are smaller and lighter and therefore easier to handle compared to implementation in only one brake control unit. They can also be manufactured more easily in existing production plants. When divided into two brake control units, each hydraulic connection between these brake control units will result in additional effort and additional costs. It is therefore advantageous to keep the number of hydraulic connections as low as possible. It is furthermore advantageous to isolate the various functions of hydraulic connections as clearly as possible. Connections via which pressure medium is sucked in should have as little hydraulic resistance as possible and therefore as large a diameter as possible. For this, it is advantageous if such connections do not have to be pressure-resistant. Conversely, pressure-bearing connections should not have a suction function.

1-13. (canceled)

14. A brake system for a motor vehicle having at least four hydraulically actuatable wheel brakes, said brake system comprising:
a first electrically actuatable pressure source;
a first electronic control device;
a second electrically actuatable pressure source;
wherein the first pressure source and the second pressure source are connected to a brake supply line to which the at least four inlet valves are connected;
an electrically actuatable inlet valve for each wheel brake;
an electrically actuatable outlet valve for each wheel brake;
a second electronic control device; and
a pressure medium reservoir;
an electrically actuatable circuit separation valve arranged in the brake supply line in such a manner that, when the circuit separation valve is closed, the brake supply line is hydraulically separated into a first line section and a second line section, wherein the first line section is hydraulically connected to the second pressure source and at least two of the at least four inlet valves, and the second line section is hydraulically connected to the first pressure source and the other two of the at least four inlet valves;
wherein the first electronic control device activates the first pressure source, the second electronic control device activates the second pressure source and the inlet and outlet valves, and the circuit separation valve is activated by the second electronic control device.

15. The brake system as claimed in claim 14, further comprising a first electrical partition and a second electrical partition which are electrically independent of one another, wherein the first pressure source and the first electronic control device are assigned to the first electrical partition and the second pressure source, the second electronic control device, the inlet and outlet valves, and the circuit separation valve are assigned to the second electrical partition.

16. The brake system as claimed in claim 14, wherein the first pressure source is activated exclusively by the first electronic control device and the second pressure source, the inlet and outlet valves, and the circuit separation valve are activated exclusively by the second electronic control device.

17. The brake system as claimed in claim 14, further comprising:
a first structural unit in which the first electrically actuatable pressure source) is arranged and which includes the first electronic control device; and
a second structural unit in which the second electrically actuatable pressure source, the electrically actuatable inlet and outlet valves and the circuit separation valve are arranged and which includes the second electronic control device.

18. The brake system as claimed in claim 17, wherein the first structural unit and the second structural unit are connected to one another by at most one pressure-resistant hydraulic connecting element.

19. The brake system as claimed in claim 17, wherein the first structural unit and the second structural unit are connected to one another by only one hydraulic connecting element, wherein said connecting element is designed to be pressure-resistant.

20. The brake system as claimed in claim 14, wherein the first pressure source is connected to the brake supply line via an electrically actuatable first separation valve, wherein the separation valve is activated by the second electronic control device.

21. The brake system as claimed in claim 20, wherein the first separation valve is designed to be normally open.

22. The brake system as claimed in claim 14, wherein the first pressure source is connected to the pressure medium reservoir via an electrically actuatable second separation valve, wherein the second separation valve is activated by the first electronic control device.

23. The brake system as claimed in claim 22, wherein the second separation valve is designed to be normally open.

24. The brake system as claimed in claim 14, wherein the first pressure source is connected to the pressure medium reservoir via a check valve which opens in the direction of the first pressure source.

25. The brake system as claimed in claim 14, wherein, in addition to the first and second pressure source, the brake system does not include a further pressure source for building up a brake pressure for actuating the wheel brakes.

26. The brake system as claimed in claim 14, further comprising an actuating unit for a vehicle driver, wherein the actuating unit is connected to at least one electronic control device for transmitting a driver demand signal and wherein there is no mechanical-hydraulic connection from the actuating unit to the wheel brakes.
